(19) United States
(12) Patent Application Publication
(10) Pub. No.: US 2023/0134073 A1
(43) Pub. Date: May 4, 2023

(54) CONTROLLING METHOD FOR SERVER AND SYSTEM PROVIDING A FAN MANAGEMENT PLATFORM

(71) Applicant: ILLIO, Seoul (KR)

(72) Inventor: Tae Keun OH, Seoul (KR)

(73) Assignee: ILLIO, Seoul (KR)

(21) Appl. No.: 17/537,095

(22) Filed: Nov. 29, 2021

(30) Foreign Application Priority Data
Oct. 29, 2021 (KR) 10-2021-0147207

(51) Int. Cl. H04L 51/52; H04L 51/046; H04L 51/00; G06Q 30/02; G06Q 50/00

(52) U.S. Cl. CPC H04L 51/32; H04L 51/046; H04L 51/12; G06Q 30/0215; G06Q 50/01

(57) ABSTRACT

Disclosed is a control method of a server. The control method includes generating a chat room in which one celeb and at least one fan are allowed to chat, wherein the celeb accesses a server through a first terminal and the fan accesses the server through a second terminal, providing, through the first terminal, a chat mode in which a chat message is allowed to be transmitted in the chat room and a reward mode in which content of the celeb is allowed to be transmitted, and providing, through the second terminal, a chat mode in which a chat message is allowed to be transmitted in the chat room and a gift mode in which a donation is allowed to be provided to the celeb, wherein, in the reward mode, an interface through which a group to which the content is to be transmitted is selected is provided, an interface through which the content is selected is provided, and the selected content is transmitted to the selected group.

### CROSS-REFERENCE TO RELATED APPLICATION

This application claims priority to and the benefit of Korean Patent Application No. 10-2021-0147207, filed on Oct. 29, 2021, the disclosure of which is incorporated herein by reference in its entirety.

### BACKGROUND

### 1. Field of the Invention

The present invention relates to a control method of a server providing a fan management platform and a system for providing a fan management platform.

### 2. Discussion of Related Art

A celeb is an abbreviation of “celebrity,” which means a famous person in English, refers to a famous person who leads trends enough to be followed by anyone, and includes not only an entertainer and a politician but also a well-known person among ordinary people classified as the general public.

For celebs, “fans” are entities that secure substantial profits, and communication with the fans and the management of their affection are very important. However, the status of a platform for celebs to manage their fans is in its infancy in the market, and an application, which applies more functions than a function that allows celebs to communicate with their fans, and the like are not provided.

Accordingly, the development of an innovative fan management platform that can be used by celebs to not only manage their fans, but also strengthen solidarity with their fans and attract their fans is required.

### SUMMARY OF THE INVENTION

The present invention is directed to providing a control method of a server providing a fan management platform and a system for providing a fan management platform.

Objects of the present invention are not limited to the above-described objects and other objects that are not described may be clearly understood by those skilled in the art from this specification and the accompanying drawings.

According to an aspect of the present invention, there is provided a control method of a server, which includes generating a chat room in which one celeb and at least one fan are allowed to chat, wherein the celeb accesses a server through a first terminal and the fan accesses the server through a second terminal, providing, through the first terminal, a chat mode in which a chat message is allowed to be transmitted in the chat room and a reward mode in which content of the celeb is allowed to be transmitted, and providing, through the second terminal, a chat mode in which a chat message is allowed to be transmitted in the chat room and a gift mode in which a donation is allowed to be provided to the celeb, wherein, in the reward mode, an interface through which a group to which the content is to be transmitted is selected is provided, an interface through which the content is selected is provided, and the selected content is transmitted to the selected group.

Solutions of the present invention are not limited to the above-described solutions and other solutions that are not described may be clearly understood by those skilled in the art from this specification and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram for describing a system for providing a fan management platform;

FIG. 2 is a system diagram for describing a system for providing a fan management platform;

FIG. 3 is a diagram for describing a configuration of a user terminal;

FIG. 4 is a flowchart for describing a control method of a server providing a fan management platform according to an embodiment;

FIG. 5 illustrates diagrams illustrating an interface in a chat mode and an interface in a gift mode according to an embodiment;

FIG. 6 illustrates diagrams illustrating an interface in a reward mode according to an embodiment; and

FIG. 7 is a diagram for describing fan management information generated based on a message that is input by a fan or a celeb in a chat mode.

### DETAILED DESCRIPTION OF EXEMPLARY EMBODIMENTS

The above-described objects, features and, advantages of the present invention will be clearly understood through the following detailed description taken in conjunction with the accompanying drawings. However, while the present invention may have various modifications and alternative forms, specific embodiments thereof are shown by way of example in the accompanying drawings and will be described in detail herein.

Like reference numerals refer to like elements in principle throughout this specification. In addition, elements having the same function within the scope of the same idea shown in the drawings of each embodiment will be described using the same reference numerals, and descriptions thereof will not be repeated.

When it is determined that detailed descriptions of related well-known functions or configurations may unnecessarily obscure the gist of the present invention, detailed descriptions thereof will be omitted. Further, the ordinal numbers (for example, first, second, etc.) used in description of the specification are used only to distinguish one element from another element.

Further, a suffix “module,” “unit,” “part,” or “portion” of an element used herein is assigned or incorporated for convenience of specification description, and the suffix itself does not have a distinct meaning or role.

In the following embodiments, the singular forms “a” and “an” are intended to also include the plural forms, unless the context clearly indicates otherwise.

In the following embodiments, the terms “comprise,” “comprising,” “include,” and/or “including,” when used herein, specify the presence of stated features or elements described in the specification, but do not preclude the presence of one or more other features or elements.

In the drawing, the size of the elements may be exaggerated or reduced for convenience of description. For example, the size and thickness of each element shown in the drawings are arbitrarily indicated for convenience of description and the present invention is not necessarily limited to the illustration.

When a certain embodiment is allowed to be implemented differently, a specific process order may be performed differently from the described order. For example, two consecutively described processes may be performed substantially at the same time or performed in an order opposite to the described order.

In the following embodiments, when elements and the like are described as being connected to each other, the elements are directly connected to each other or the elements are indirectly connected to each other with another element interposed therebetween.

For example, in this specification, when elements and the like are described as being electrically connected to each other, the elements are directly and electrically connected to each other or the elements are indirectly and electrically connected to each other with another element interposed therebetween.

According to an embodiment of the present invention, a control method of a server providing a fan management platform, which includes generating a chat room in which one celeb and at least one fan are allowed to chat, wherein the celeb accesses a server through a first terminal and the fan accesses the server through a second terminal, providing, through the first terminal, a chat mode in which a chat message is allowed to be transmitted in the chat room and a reward mode in which content of the celeb is allowed to be transmitted, and providing, through the second terminal, a chat mode in which a chat message is allowed to be transmitted in the chat room and a gift mode in which a donation is allowed to be provided to the celeb, wherein the reward mode is operated so that an interface through which a group to which the content is to be transmitted is selected is provided, an interface through which the content is selected is provided, and the selected content is transmitted to the selected group.

The control method may further include classifying a group to which the content is to be transmitted in the reward mode.

The group may be classified on the basis of at least one of a speed of replying to the chat message of the celeb, a consumption rate of the content transmitted by the celeb, a participation rate of an event generated by the celeb, and an amount of a donation provided to the celeb.

The group may include at least one of a group of very important person (VIP) fans, a group of potential VIP fans, a group of departed VIP fans, a group of new fans, and a group of departed fans.

The chat mode may be implemented so that a public chat message that is disclosed to all participants in the chat room and a secret chat message that is transmitted to a selected one of the participants in the chat room are allowed to be transmitted.

The control method may further include providing, through the second terminal, a paid subscription service application page for subscribing to the daily life of the celeb.

The control method may further include distributing profits according to a paid subscription service application to the celeb at a preset ratio.

According to an embodiment of the present invention, a system for providing a fan management platform which includes a first terminal configured to operate in a chat mode in which a chat message is allowed to be transmitted in a chat room in which one celeb and at least one fan are allowed to chat and operate in a reward mode in which content of the celeb is allowed to be transmitted, a second terminal configured to operate in a chat mode in which a chat message is allowed to be transmitted in the chat room and operate in a gift mode in which a donation is allowed to be provided to the celeb, and a server configured to classify a group to which the content is to be transmitted when the first terminal operates in the reward mode, wherein the group is classified on the basis of at least one of a speed of replying to the chat message of the celeb, a consumption rate of the content transmitted by the celeb, a participation rate of an event generated by the celeb, and an amount of a donation provided to the celeb.

Hereinafter, a user terminal, a server, and a system that provide a fan management platform of the present invention, and a control method thereof will be described with reference to the accompanying drawings.

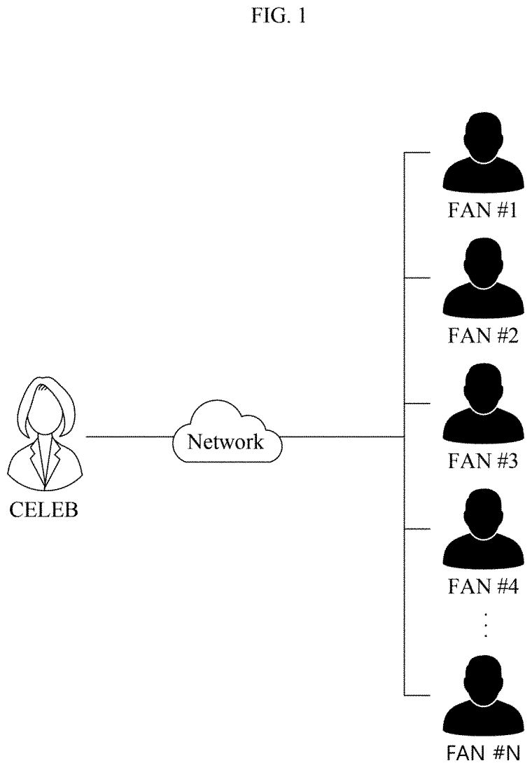

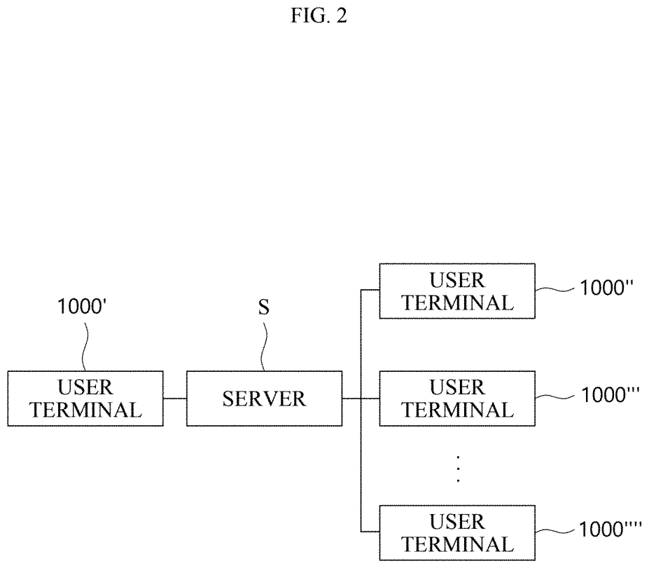

FIG. 1 is a conceptual diagram for describing a system for providing a fan management platform, and FIG. 2 is a system diagram for describing the system for providing the fan management platform.

One celeb may have one or more fans, and the fans and the celeb may communicate through a communication network through which data transmission is possible. According to an embodiment of the present invention, a celeb and fans may participate in communication using user terminals and a platform through which the fans and the celeb may communicate may be managed by a server.

Referring to FIG. 2, the system for providing the fan management platform may include a user terminal 1000′ and a server.

According to an embodiment, the server may provide a chat mode, in which chat messages may be transmitted in a chat room through the user terminal 1000′ accessed by a celeb, and a reward mode in which the content of the celeb may be transmitted. The server may provide a chat mode in which chat messages may be transmitted in the chat room through user terminals 1000″, 1000′″, and 1000″″ accessed by the fans, and a gift mode in which a donation may be provided to the celeb.

More specifically, the server may provide an interface through which a group, to which content is to be transmitted, is selected and/or an interface through which content is selected, through the user terminal 1000′ accessed by the celeb. The server may transmit the selected content to the user terminals 1000″, 1000′″, and 1000″″ of the fans belonging to the group to which the selected content may be transmitted.

According to another embodiment, a series of operations for providing the above-described fan management platform may be performed by a user terminal 1000. More specifically, the series of operations for providing the above-described fan management platform may be performed through a program downloaded to the user terminal 1000, and if necessary, a service may be provided to transmit/receive data to/from another user terminal 1000, which is connected to the user terminal 1000, or the server S.

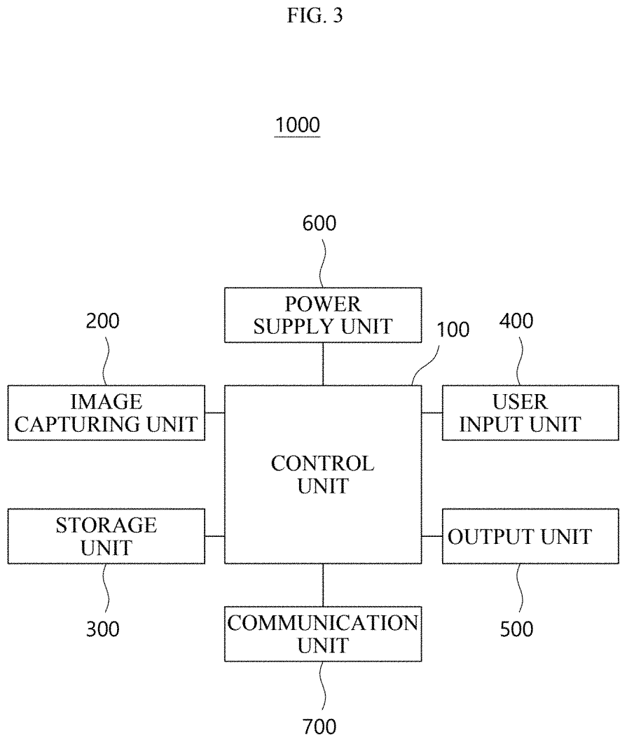

FIG. 3 is a diagram for describing a configuration of a user terminal. Referring to FIG. 3, a user terminal 1000 may include a control unit 100, an image capturing unit 200, a storage unit 300, a user input unit 400, an output unit 500, a power supply unit 600, and a communication unit 700. In this case, the user terminal 1000 may include a portable information and communication device, for example, a smartphone, a tablet personal computer (PC), or the like.

The image capturing unit 200 is a digital camera and may include an image sensor and an image processing unit. The image sensor is a device that converts an optical image into an electrical signal and may be configured as a chip in which a plurality of photodiodes are integrated. For example, the image sensor may include a charge-coupled device (CCD), a complementary metal-oxide-semiconductor (CMOS), or the like. Meanwhile, the image processing unit may generate image information by image processing a captured result.

The storage unit 300 is a storage unit for storing data that can be read by a microprocessor and may include a hard disk drive (HDD), a solid state disk (SSD), a silicon disk drive (SDD), a read-only memory (ROM), a random access memory (RAM), a compact disc ROM (CD-ROM), magnetic tape, a floppy disk, and an optical data storage device. Data received by the user terminal 1000 may be stored in the storage unit 300.

The user input unit 400 may receive an input from a user of the user terminal 1000. The received input may be transmitted to the control unit 100. According to an embodiment, the user input unit 400 may receive the user input through a touch display. Further, the user input unit 400 may refer to a user interface screen on which a command is input from the user.

The output unit 500 outputs various types of information according to a control command of the control unit 100. According to an embodiment, the output unit 500 may output information through a display panel. More specifically, the output unit 500 may output the information through the display panel. However, the output unit 500 is not limited to the display panel and may include various units capable of outputting information, such as a speaker and the like.

The power supply unit 600 includes a battery, and the battery may be embedded in the user terminal 1000 or provided to be detachable from the outside. The power supply unit 600 may supply power required by each component of the user terminal 1000.

The communication unit 700 may include a wireless communication module and/or a wired communication module. Here, the wireless communication module may include a Wi-Fi communication module, a cellular communication module, or the like.

The control unit 100 may include at least one processor. In this case, each processor may perform a predetermined operation by executing at least one instruction stored in a memory. Specifically, the control unit 100 may control the overall operation of the components included in the user terminal 1000. In other words, the user terminal 1000 may be controlled or operated by the control unit 100.

According to the embodiment of the present invention, the celeb may transmit a secret message to one fan through the user terminal 1000 or transmit a public message to one or more fans participating in a chat room. For example, the celeb may input content to be transmitted as a secret message or a public message through the user terminal 1000. As a more specific example, the user terminal 1000 may obtain the message content through the user input unit 400 and then transmit the message content to the server S and/or the terminal 1000 of the fan through the communication unit 700.

According to the embodiment of the present invention, the celeb may transmit content to one or more fans. For example, the celeb may input a group to which the content is to be transmitted and the content to be transmitted, through the user terminal 1000. As a more specific example, the user terminal 1000 may output an interface GSI, through which a group to which content is to be transmitted may be selected, through the output unit 500, and may receive a selection of the group, to which the content is to be transmitted, through the user input unit 400. The user terminal 1000 may transmit information about the group, to which the selected content is to be transmitted, to the server S and/or the terminal 1000 of the fan through the communication unit 700.

According to the embodiment of the present invention, the fan may transmit a secret message to the celeb or transmit a public message to one or more fans and the celeb who are participating in the chat room to be disclosed, through the user terminal 1000. For example, the fan may input content to be transmitted as a reply to the secret message or as a public message through the user terminal 1000. As a more specific example, the user terminal 1000 may obtain the message content through the user input unit 400 and then transmit the message content to the server S and/or the terminal 1000 of the fan through the communication unit 700.

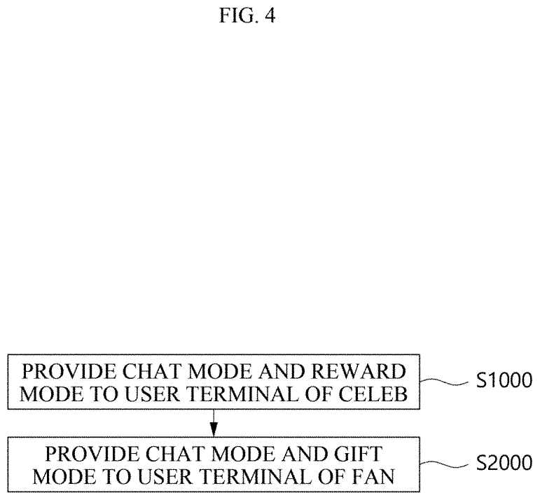

FIG. 4 is a flowchart for describing a control method of a server providing a fan management platform according to an embodiment.

A server S may generate a chat room in which one celeb and at least one fan are allowed to chat. The server S may provide a chat mode and a reward mode to a user terminal of the celeb (S1000).

The chat mode may be implemented so that a public chat message that is disclosed to all participants in the chat room and a secret chat message that is transmitted to a selected one of the participants in the chat room may be transmitted.

The reward mode may be implemented so that an interface through which a group to which the content is to be transmitted may be selected is provided, an interface through which the content may be selected is provided, and the selected content is transmitted to the selected group.

The server S may classify the group to which the content is to be transmitted in the reward mode. The server S may segment the fans as a candidate group, to which the content is to be transmitted, so as to select the group to which the content is to be transmitted in the reward mode.

The server S may classify the group to which the content is to be transmitted in the reward mode in consideration of whether the fan is a fan who recently communicated on a chat service, a fan who frequently accesses the chat service, or a fan who spends a lot of money on the chat service. As a specific example, the server S may classify the group on the basis of at least one of a speed of replying to the chat message of the celeb, a consumption rate of the content transmitted by the celeb, a period of chat service access, a participation rate of an event generated by the celeb, an amount of a donation provided to the celeb, and an amount of a donation recently provided to the celeb.

The group may include at least one of a group of very important person (VIP) fans, a group of potential VIP fans, a group of departed VIP fans, a group of infrequent VIP fans, a group of departed potential VIP fans, a group of new fans, and a group of departed fans. The present invention is not limited thereto, and the group and criteria for classifying the group may vary.

The server S may provide a chat mode and a gift mode to a user terminal of the fan (S2000).

The chat mode may be implemented so that a public chat message that is disclosed to all participants in the chat room and a secret chat message that is transmitted to a selected one among the participants in the chat room may be transmitted. Alternatively, the chat mode may be implemented so that a public chat message that is disclosed to all the participants in the chat room and a secret chat message that is transmitted only to the celeb may be transmitted.

The gift mode may be implemented so that a donation may be provided to the celeb.

According to an embodiment of the present invention, through the user terminal 1000 of the fan, a paid subscription service application page for subscribing to the daily life of the celeb may be provided and a paid subscription service application may be transmitted to the server S. The server S may provide content and/or access rights according to the paid subscription service to the user terminal 1000 of the fan, and may distribute profits according to the paid subscription service application to the user terminal 1000 of the celeb or an account of the celeb.

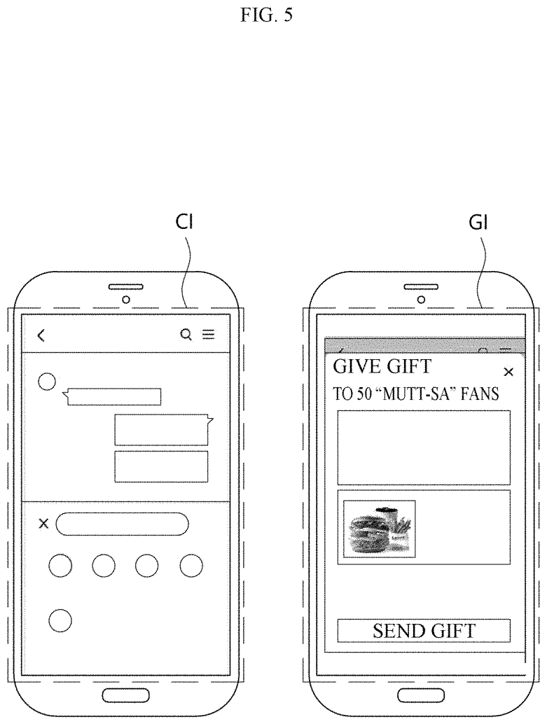

FIG. 5 illustrates diagrams illustrating an interface CI in a chat mode and an interface GI in a gift mode according to an embodiment.

The interface CI in the chat mode may include an area for inputting a message. According to an embodiment, in the interface CI in the chat mode, a mission request function in which a celeb provides a mission to his/her fans and a gift function in which the fan provides a gift to the celeb may be implemented.

The interface CI in the gift mode may include a gift sending area in which the celeb provides gifts to one or more fans. According to an embodiment, the interface CI in the gift mode may include an area in which the celeb may input messages to be transmitted along with gifts to several selected fans.

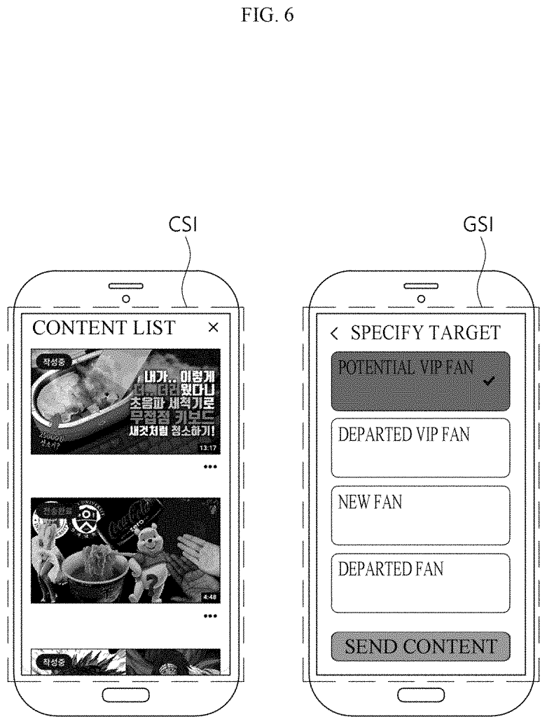

FIG. 6 illustrates diagrams illustrating an interface in a reward mode according to an embodiment.

In the reward mode, an interface CSI through which content is selected and an interface GSI through which a group to which the content is to be transmitted is selected may be provided. According to an embodiment, the interface CSI through which the content is selected may be provided to the user terminal 1000 of the celeb first, and when a user input with respect to one piece of content is obtained through the user input unit 400, the interface GSI through which the group to which the content is to be transmitted is selected may be provided.

Preferred content of the celeb may be output to the interface CSI through which the content is selected, personal content of the celeb may be output to the interface CSI, or various pieces of content may be output to the interface CSI without being limited thereto.

The interface GSI through which the group to which the content is to be transmitted is selected may be provided to a selection interface corresponding to candidate groups which will transmit content classified according to an operation in the server S. According to an embodiment, the interface GSI through which the group to which the content is to be transmitted is selected may be implemented so that one or more of potential VIP fans, departed VIP fans, new fans, and departed fans may be selected and the content may be transmitted.

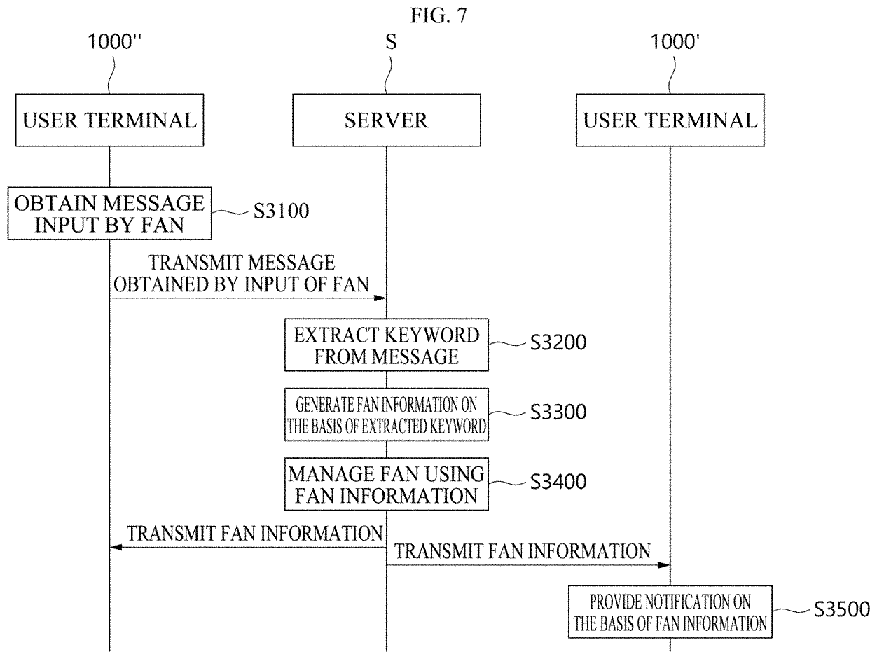

FIG. 7 is a diagram for describing fan management information generated based on a message that is input by a fan or a celeb in a chat mode.

Referring to FIG. 7, a user terminal 1000″ may obtain a message input by a fan (S3100). In this case, the user terminal 1000″ may be a terminal accessed by the fan, and the message input by the fan may be obtained in a chat mode on the user terminal 1000″ and then stored in a storage unit.

The user terminal 1000″ may transmit the message obtained by the input of the fan to a server S. The server S may receive the message from the user terminal 1000″ and then extract at least one keyword from the message (S3200). In this case, the keyword may be obtained from the message and may be at least one of a plurality of words, sentences, numbers, and symbols included in the message.

The keyword may be one or more words or sentences that may represent the content of the message. For example, the keyword may be personal information (e.g., name, address, birthday, occupation, age, gender, etc.) of the fan or an interest (e.g., anniversary, hobby, future hopes etc.) of the fan, but the present invention is not limited thereto, and the keyword may be information related to the fan who input the message.

Although not illustrated in the drawings, the extraction of the keyword from the message input by the fan is not limited to being performed in the server S and may be performed on the user terminal 1000″.

The server S may generate fan information on the basis of the extracted keyword through a fan information generation operation S3300. The server S may generate information related to the fan on the basis of at least one of a plurality of keywords. For example, the server S may use at least one of a plurality of extracted keywords to generate personal information (e.g., name, address, birthday, occupation, age, gender, etc.) of the fan, an interest (e.g., anniversary, hobby, future hopes, etc.) of the fan, or other pieces of information related to the fan.

The server S may manage the fan using the generated fan information through a fan management operation S3400 and transmit the fan information to a user terminal 1000′ that the celeb accesses.

The user terminal 1000′ that the celeb accesses may receive the fan information from the server S and then store the fan information. The user terminal 1000′ may provide a notification according to a predetermined criterion on the basis of the stored fan information.

As an example, in the case in which the celeb chats with a fan, when there is stored fan information on the fan who is chatting, the user terminal 1000′ may extract information (e.g., personal information, interests, etc.) on the fan from the corresponding fan information and then output the extracted information on a display.

As another example, the user terminal 1000′ may provide a notification to the celeb at a specific time point or time on the basis of the fan information. For example, the user terminal 1000′ may obtain birthday information or anniversary information of the fan from the fan information and then provide a notification to the celeb on a corresponding date.

Meanwhile, the server S may transmit the generated fan information to the user terminal 1000″ that the fan accesses. Although not illustrated in the drawings, the user terminal 1000″ may provide a notification or the like to the fan on the basis of the fan information received from the server S.

According to the embodiment of the present invention, a platform, through which a celeb can chat with fans and transmit content to the fans and the fans can chat with their celeb and send gifts to the celeb, can be provided.

According to the embodiment of the present invention, a celeb can transmit selected content to fans segmented based on criteria suitable for fan management, and thus solidarity with his/her fans can be secured.

Effects of the present invention are not limited to the above-described effects and other effects that are not described may be clearly understood by those skilled in the art from this specification and the accompanying drawings.

Features, structures, and effects described in the above-described exemplary embodiments are included in at least one exemplary embodiment of the present invention but are not necessarily limited to only one exemplary embodiment. Further, features, structures, and effects exemplified in each exemplary embodiment may be embodied by being combined with another exemplary embodiment or modified by those skilled in the art. It should be interpreted that contents related to such combinations and modifications are included in the scope of the present invention.

While the present invention has been particularly described with reference to embodiments, the embodiments are only exemplary embodiments of the present invention and the present invention is not intended to be limited thereto. It will be understood by those skilled in the art that modifications and applications in other forms may be made without departing from the spirit and scope of the present invention. That is, each component specifically shown in the embodiments may be modified and embodied. In addition, it should be understood that differences related to these modifications and applications are within the scope of the present invention as defined in the appended claims.

1. A control method of a server providing a fan management platform, comprising:
generating a chat room in which one celeb and at least one fan are allowed to chat, wherein the celeb accesses a server through a first terminal and the fan accesses the server through a second terminal;
providing, through the first terminal, a chat mode in which a chat message is allowed to be transmitted in the chat room and a reward mode in which content of the celeb is allowed to be transmitted;
providing, through the second terminal, a chat mode in which a chat message is allowed to be transmitted in the chat room and a gift mode in which a donation is allowed to be provided to the celeb;
extracting at least one keyword from the chat message transmitted in the chat room;
generating fan information based on the at least one keyword, wherein the fan information includes at least one of personal information of the fan and interests of the fan;
transmitting the fan information to the first terminal; and
performing management of the fan based on the fan information;
wherein the reward mode provides an interface for selecting a group including at least one fan, provides an interface for selecting reward content, and operates to transmit the reward content to the group, wherein the reward content is to be transmitted to the group among the content of the celeb,
wherein the first terminal provides a notification according to a predetermined criterion based on the fan information.

2. The control method of claim 1, further comprising classifying the group to which the content is to be transmitted in the reward mode.

3. The control method of claim 2, wherein the group is classified on the basis of at least one of a speed of replying to the chat message of the celeb, a consumption rate of the content transmitted by the celeb, a participation rate of an event generated by the celeb, and an amount of a donation provided to the celeb.

4. The control method of claim 3, wherein the group includes at least one of a group of very important person (VIP) fans, a group of potential VIP fans, a group of departed VIP fans, a group of new fans, and a group of departed fans.

5. The control method of claim 4, wherein the chat mode is implemented so that a public chat message that is disclosed to all participants in the chat room and a secret chat message that is transmitted to a selected one of the participants in the chat room are allowed to be transmitted.

6. The control method of claim 5, further comprising providing, through the second terminal, a paid subscription service application page for subscribing to the daily life of the celeb.

7. The control method of claim 6, further comprising distributing profits according to a paid subscription service application to the celeb at a preset ratio.

8. A system for providing a fan management platform, comprising:
a first terminal configured to operate in a chat mode in which a chat message is allowed to be transmitted in a chat room in which one celeb and at least one fan are allowed to chat and operate in a reward mode in which content of the celeb is allowed to be transmitted;
a second terminal configured to operate in a chat mode in which a chat message is allowed to be transmitted in the chat room and operate in a gift mode in which a donation is allowed to be provided to the celeb; and
a server configured to classify a group to which the content is to be transmitted when the first terminal operates in the reward mode, wherein the group is classified on the basis of at least one of a speed of replying to the chat message of the celeb, a consumption rate of the content transmitted by the celeb, a participation rate of an event generated by the celeb, and an amount of a donation provided to the celeb,
wherein the server extracts at least one keyword from the chat message transmitted in the chat room, generates fan information based on the at least one keyword, transmits the fan information to the first terminal, and performs management of the fan based on the fan information,
wherein the fan information includes at least one of personal information of the fan and interests of the fan, wherein the first terminal provides a notification according to a predetermined criterion based on the fan information.

9. The control method of claim 1, wherein the first terminal determines a specific time point or time related to the anniversary of the fan based on the fan information, and provides the notification through a display at the specific time point or time.

10. The control method of claim 1, when the celeb chats with the fan, wherein the first terminal extracts information about the fan who is chatting if the fan information includes the information about the fan who is chatting, and
wherein the first terminal outputs information about the fan who is chatting on a display.
